(19) United States
(12) Patent Application Publication
(10) Pub. No.: US 2017/0001290 A1
(43) Pub. Date: Jan. 5, 2017

(54) Connecting rod Device for Tools

(71) Applicant: Shih-Chieh Liu, Taichung City (TW)

(72) Inventor: Shih-Chieh Liu, Taichung City (TW)

(21) Appl. No.: 15/049,841

(22) Filed: Feb. 22, 2016

(30) Foreign Application Priority Data
Jul. 3, 2015 (TW) 104121720

(51) Int. Cl. B25B 23/00

(52) U.S. Cl. CPC B25B 23/0035; B25B 23/0021

(57) ABSTRACT

A connecting rod device for tools contains: a body, a retainer, and a slidable sleeve. The body includes a polygonal fitting groove and a trench communicating with the fitting groove. The retainer is partially accommodated in the trench and includes a first face and a second face which correspond to the trench, the retainer also includes a locking protrusion extending into the fitting groove from a first end of the retainer, and a second end of the retainer extends out of the body. The slidable sleeve is fitted with the body and includes a first stop rim for pushing the first face of the retainer, and the slidable sleeve also includes a pushing element for pushing the second face of the retainer, such that the first stop rim and the pushing element of the slidable sleeve push the retainer to move in the trench.

### FIELD OF THE INVENTION

The present invention relates to a connecting rod device which is capable of connecting with tools stably or removing from the tools easily.

### BACKGROUND OF THE INVENTION

Referring to FIGS. 1 and 2, a conventional connecting rod 10 for tools contains a body 11 and a C ring 12, the body 11 includes a polygonal fitting groove 111 defined on one end thereof so as to fit with an operational tool, such as a socket 20. The body 11 also includes a fitting column 112 configured to fit with a driving tool, such as a wrench or a pneumatic tool, wherein the fitting groove 111 of the body 11 has a trench 113 for accommodating the C ring 12. The socket 20 includes a polygonal coupling post 201 arranged on one end thereof and includes a locking trough 202 defined on the coupling post 201, such that when the coupling post 201 of the socket 20 is fitted with the fitting groove 111 of the body 11, the C ring 12 clamps with the locking trough 202 of the socket 20 so as to avoid a removal of the socket 20 from the fitting groove 111 of the body 11. However, the C ring 12 cannot clamp the body 11 stably, and the socket 20 removes from the fitting groove 111 of the body 11 easily. For example, when the fitting column 112 of the body 11 fits with the pneumatic tool, the socket 20 removes from the fitting groove 111 of the body 11 easily because of vibration of the pneumatic tool.

The present invention has arisen to mitigate and/or obviate the afore-described disadvantages.

### SUMMARY OF THE INVENTION

The primary objective of the present invention is to provide a connecting rod device for tools which contains a body, a retainer, and a slidable sleeve, wherein the body includes a polygonal fitting groove defined on a first end thereof and includes a trench formed on an outer wall thereof adjacent to the first end of the body and communicating with the fitting groove; the retainer is partially accommodated in the trench of the body and includes a first face and a second face which correspond to the trench, the retainer also includes a locking protrusion extending into the fitting groove of the body from a first end of the retainer, and a second end of the retainer extends out of the outer wall of the body; the slidable sleeve is fitted with the outer wall of the body and includes a first stop rim arranged on one end thereof so as to push the first face of the retainer, the slidable sleeve also includes a pushing element fixed therein so as to push the second face of the retainer, such that when the slidable sleeve is pushed, its first stop rim pushes the first face of the retainer toward a locking position, and the locking protrusion of the retainer fixed the tools stably.

Another objective of the present invention is to provide a connecting rod device for tools in which the body includes the polygonal fitting groove so as to fit with an operation tool and includes the trench formed on the outer wall thereof and communicating with the fitting groove; the retainer is partially accommodated in the trench of the body and includes the first face and the second face which correspond to the trench, the retainer also includes the locking protrusion extending into the fitting groove of the body from the first end of the retainer, and the second end of the retainer extends out of the outer wall of the body; the slidable sleeve is fitted with the outer wall of the body and includes the first stop rim arranged on the one end thereof so as to push the first face of the retainer, the slidable sleeve also includes the pushing element fixed therein so as to push the second face of the retainer, such that when the slidable sleeve is pushed, its pushing element pushes the second face of the retainer toward a unlocking position so that the locking protrusion of the retainer removes from the operational tool, thus replacing the operational tool easily.

### BRIEF DESCRIPTION OF THE DRAWINGS

FIG. 1 is a perspective view showing the operation of a conventional connecting rod for tools.

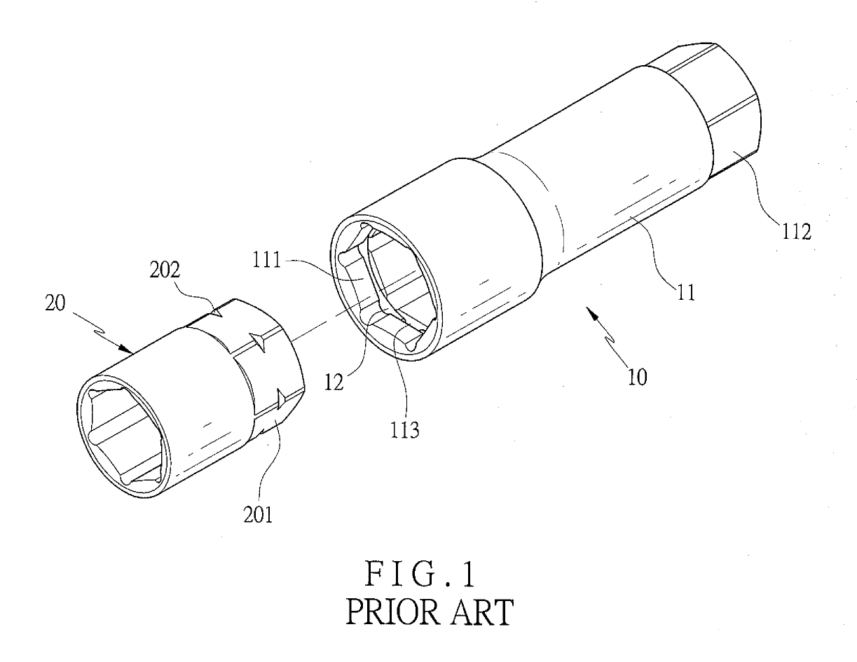

FIG. 2 is a cross sectional view showing the operation of the conventional connecting rod for the tools.

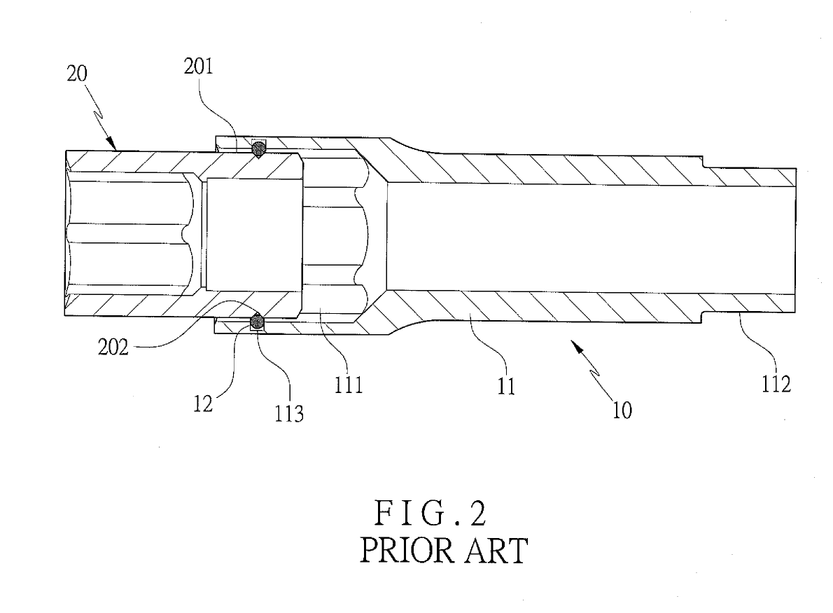

FIG. 3 is a perspective view showing the exploded components of a connecting rod device for tools according to a preferred embodiment of the present invention.

FIG. 4 is a perspective view showing the assembly of the connecting rod device for the tools according to the preferred embodiment of the present invention.

FIG. 5 is a cross sectional view showing the assembly of the connecting rod device for the tools according to the preferred embodiment of the present invention.

FIG. 6 is a cross sectional view showing the operation of the connecting rod device for the tools according to the preferred embodiment of the present invention.

FIG. 7 is another cross sectional view showing the operation of the connecting rod device for the tools according to the preferred embodiment of the present invention.

FIG. 8 is also another cross sectional view showing the operation of the connecting rod device for the tools according to the preferred embodiment of the present invention.

FIG. 9 is still another cross sectional view showing the operation of the connecting rod device for the tools according to the preferred embodiment of the present invention.

FIG. 10 is another cross sectional view showing the operation of the connecting rod device for the tools according to the preferred embodiment of the present invention.

FIG. 11 is also another cross sectional view showing the operation of the connecting rod device for the tools according to the preferred embodiment of the present invention.

FIG. 12 is still another cross sectional view showing the operation of the connecting rod device for the tools according to the preferred embodiment of the present invention.

### DETAILED DESCRIPTION OF THE PREFERRED EMBODIMENTS

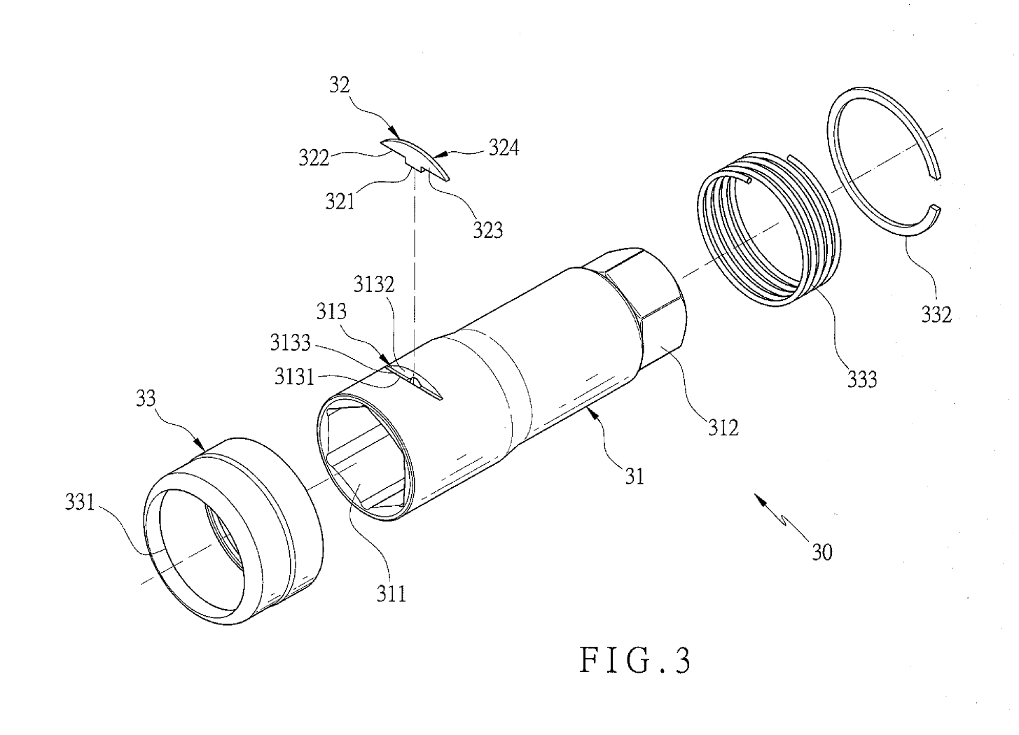

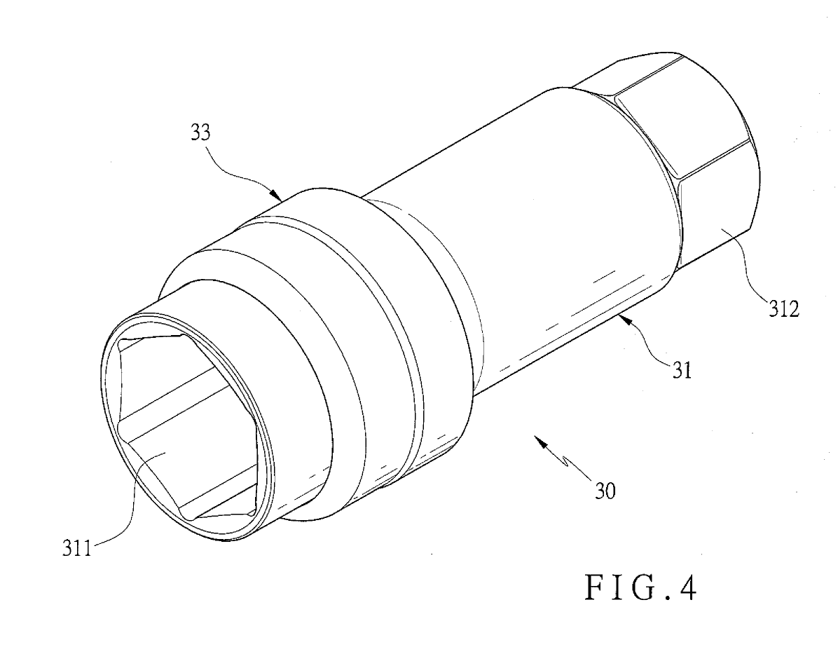

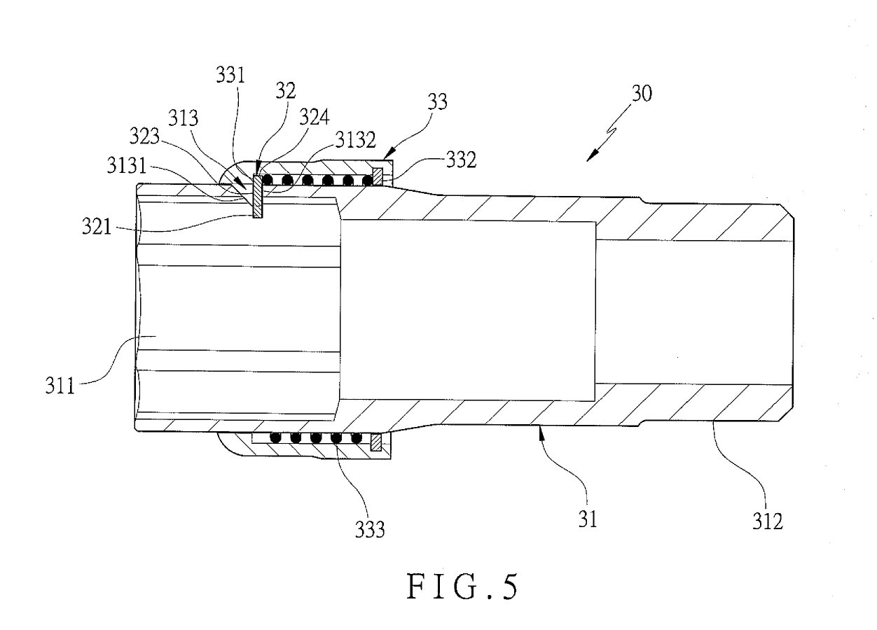

With reference to FIGS. 3 to 5, a connecting rod device 30 for tools according to a preferred embodiment of the present invention comprises: a body 31, a retainer 32, and a slidable sleeve 33. The body 31 is hollow and includes a polygonal fitting groove 311 defined on a first end thereof so as to fit with an operational tool (such as a socket or a screwdriver bit), the body 31 also includes a polygonal fitting column 312 arranged on a second end thereof so as to fit with a driving tool (such as a wrench or a pneumatic tool). The body 31 further includes a trench 313 formed on an outer wall thereof adjacent to the first end of the body 31 and communicating with the fitting groove 311. In this embodiment, the trench 313 has a tilted fence 3131 formed on a first side thereof, a straight fence 3132 arranged on a second side thereof, and a bottom face 3133 defined between the tilted fence 3131 and the straight fence 3132. In this embodiment, the trench 313 is in communication with one of corners of the fitting groove 311. The retainer 32 is partially accommodated in the trench 313 of the body 31. In this embodiment, the retainer 32 includes a first face 323 corresponding to the tilted fence 3131 of the trench 313 and includes a second face 324 corresponding to the straight fence 3132 of the trench 313. The retainer 32 also includes a locking protrusion 321 extending into the one corner of the fitting groove 311 of the body 31 from a first end of the retainer 32, and a second end of the retainer 32 extends out of the outer wall of the body 31. In this embodiment, the retainer 32 further includes an extension 322 extending outwardly from two sides of the locking protrusion 321 so as to contact with the bottom face 3133 of the trench 313 of the body 31, such that the retainer 32 moves on the tilted face 3131 and the straight fence 3132 of the trench 313 along the bottom face 3133 of the trench 313, and when the second face 324 of the retainer 32 is stopped by the straight fence 3132 of the trench 313, the locking protrusion 321 of the retainer 32 moves toward a locking position, and when the first face 323 of the retainer 32 is stopped by the tilted fence 3131 of the trench 313, the locking protrusion 321 of the retainer 32 moves toward a unlocking position. The slidable sleeve 33 is fitted with the outer wall of the body 31 and includes a first stop rim 331 arranged on one end thereof so as to push the first face 323 of the retainer 32, the slidable sleeve 321 also includes a pushing element fixed therein so as to push the second face 324 of the retainer 32, such that the first stop rim 331 and the pushing element of the slidable sleeve 33 push the retainer 32 to move in the trench 313. In this embodiment, the pushing element of the slidable sleeve 33 is a spring 333, a first end of which pushes the second face 324 of the retainer 32. The slidable sleeve 33 further includes a second stop rim 332 which is a C ring for pushing a second end of the spring 333, such that the spring 333 pushes the second stop rim 332 of the slidable sleeve 33, and the first stop rim 331 of the slidable sleeve 33 pushes the first face 323 of the retainer 32 so that the second face 324 of the retainer 32 is stopped by the straight fence 3132 of the trench 313 of the body 31, and the locking protrusion 321 of the retainer 32 moves at the locking position.

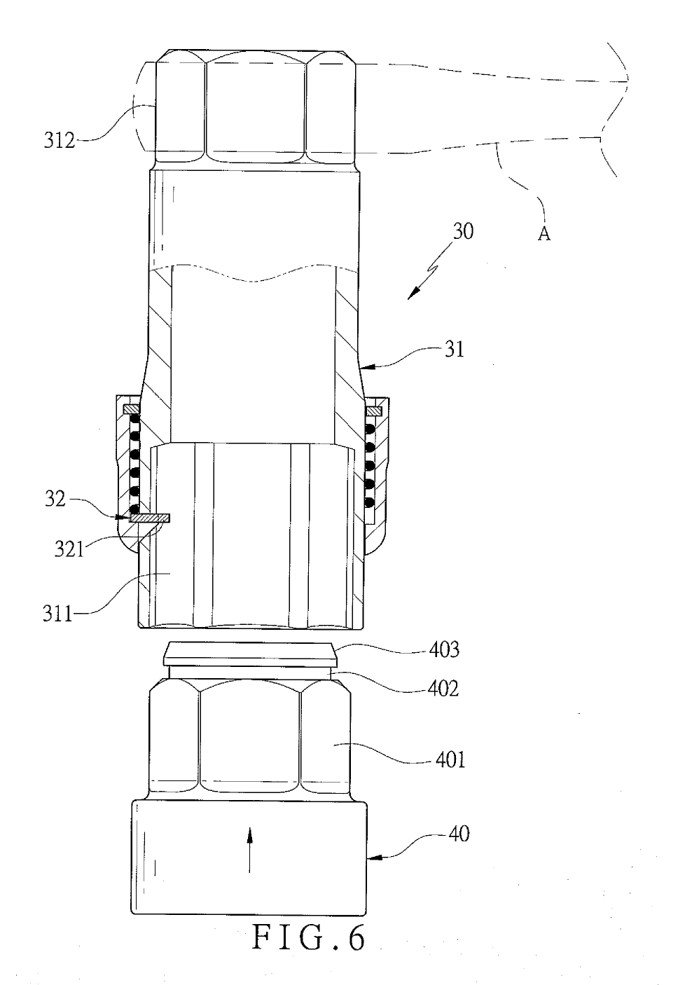

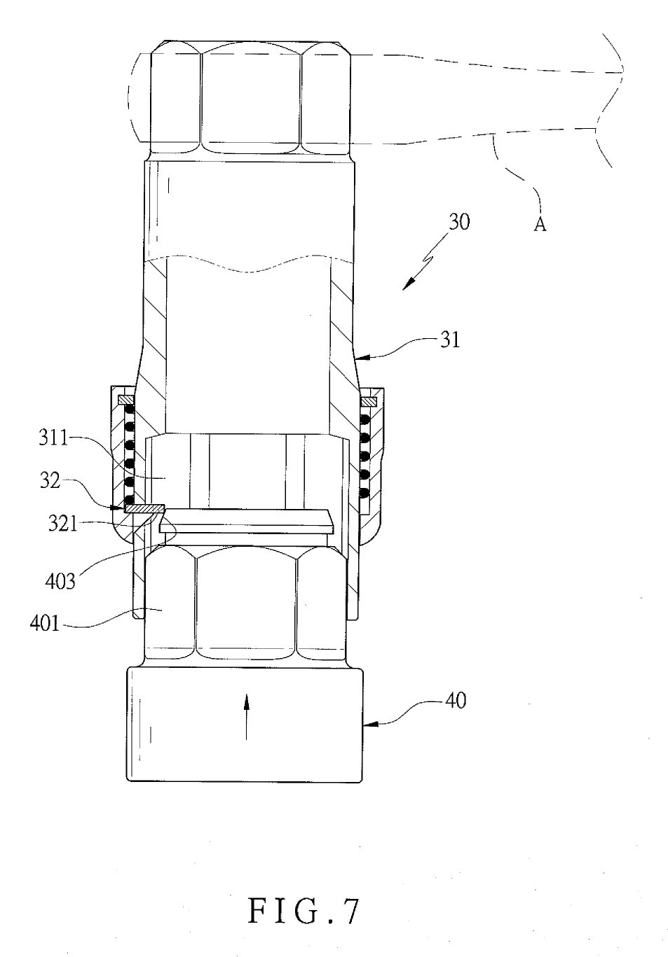

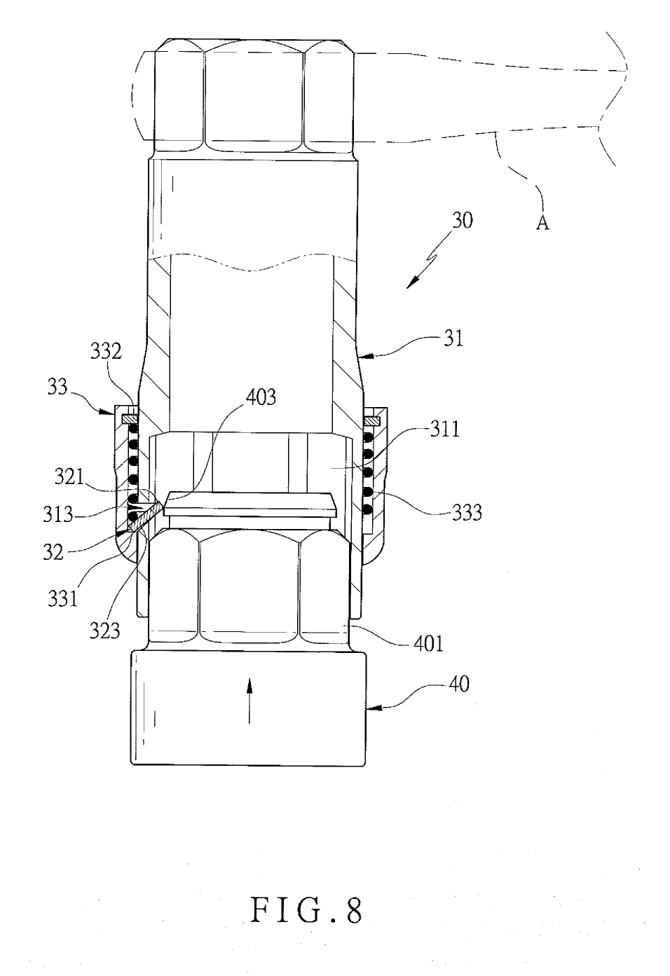

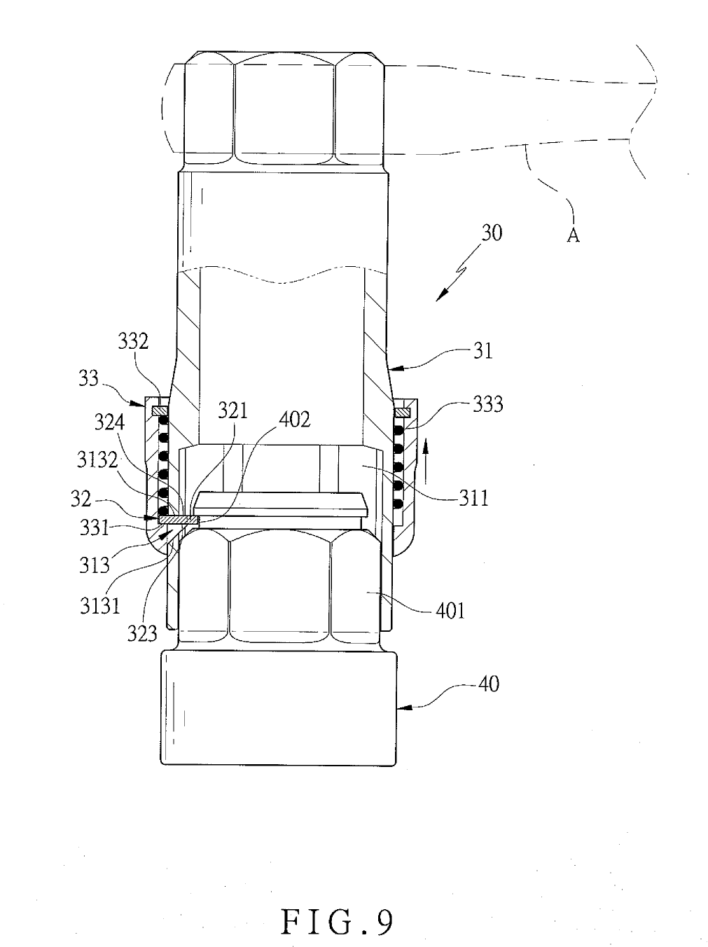

Referring to FIG. 6, in operation, the fitting column 312 of the body 31 is fitted with the wrench A, and the fitting groove 311 of the body 31 is fitted with the socket 40, wherein the socket 40 has a polygonal coupling post 401, a retaining trough 402 defined on the coupling post 401, and a beveled guiding face 403. In this embodiment, an external diameter of the beveled guiding face 403 is less than a diagonal distance of the coupling post 401 so that the locking protrusion 321 moves in the fitting groove 311 of the body 31. As shown in FIG. 7, when the body 31 is fitted with the socket 40, the locking protrusion 321 of the retainer 32 is located at the unlocking position, so when the coupling post 401 of the socket 40 fits with the fitting groove 311 of the body 31, the beveled guiding face 403 of the coupling post 401 of the socket 40 contacts with the locking protrusion 321 of the retainer 32. Referring further to FIG. 8, the socket 40 is pushed into the fitting groove 311 of the body 31, and the beveled guiding face 403 of the socket 40 pushes the locking protrusion 321 of the retainer 32 so that the retainer 32 moves in the trench 313, and the first face 323 of the retainer 32 reversely pushes the first stop rim 331 of the slidable sleeve 33 to drive the slidable sleeve 33 to move to the body 31, and the second stop rim 332 of the slidable sleeve 33 presses the spring 333. With reference to FIG. 9, when the socket 40 is pushed continuously and its retaining trough 402 moves to the locking protrusion 321 of the retainer 32, the spring 333 reversely pushes the second stop rim 332 of the slidable sleeve 33 so that the slidable sleeve 33 moves to the second end of the body 31, and the first stop rim 331 of the slidable sleeve 33 pushes the first face 323 of the retainer 32 oppositely, hence the retainer 32 moves and the straight fence 3132 of the trench 313 of the body 31 stops the second face 324 of the retainer 32, such that the locking protrusion 321 of the retainer 32 moves toward the locking position so as to retain in the retaining trough 402 of the socket 40, thus fitting the connecting rod device 30 with the socket 40. When the socket 40 is pulled away from the connecting rod device 30, the retainer 32 is limited by the straight fence 3132 of the trench 313 of the body 31, so the locking protrusion 321 of the retainer 32 fixes the socket 40 stably.

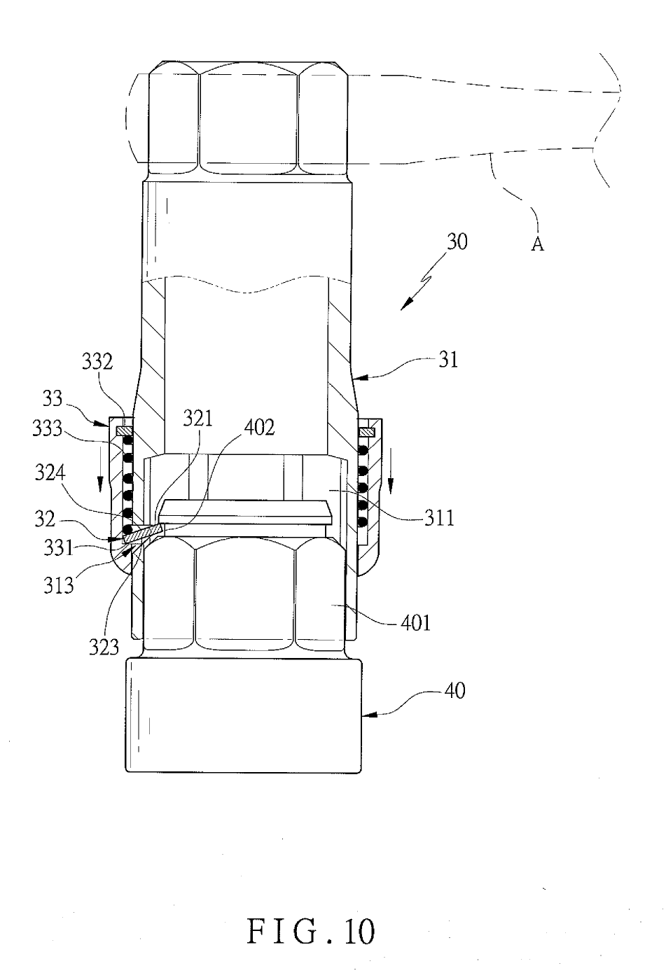

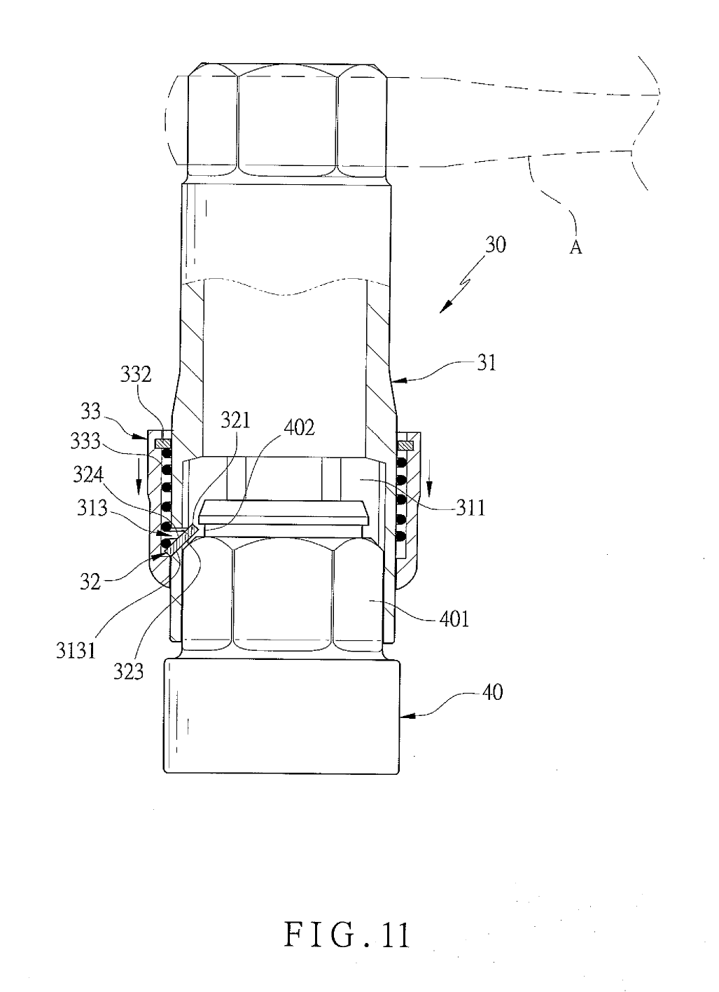

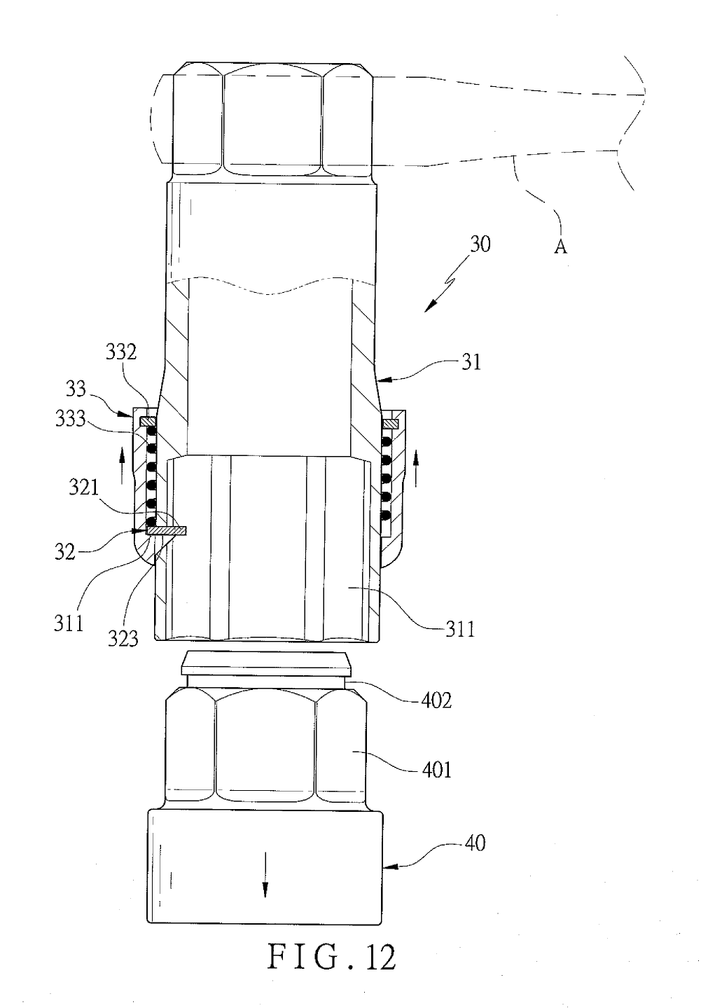

Referring to FIG. 10, as desiring to remove and replace the socket 40, the slidable sleeve 33 is pushed so that the first stop rim 331 of the slidable sleeve 33 removes from the first face 323 of the retainer 32, and the second stop rim 332 of the slidable sleeve 33 pushes the spring 333 to abut against the second face 324 of the retainer 32, such that the retainer 32 moves in the trench 313 of the body 31. As shown in FIG. 11, the slidable sleeve 33 is pushed continuously so that the spring 333 of the slidable sleeve 33 pushes the second face 324 of the retainer 32 until the first face 323 of the retainer 32 is stopped by the tilted fence 3131 of the trench 313 of the body 31, hence the locking protrusion 321 of the retainer 32 moves toward the unlocking position so as to remove from the retaining trough 402 of the socket 40. Referring to FIG. 12, as the locking protrusion 321 of the retainer 32 removes from the retaining trough 402 of the socket 40, the socket 40 is removed and the slidable sleeve 33 is released so that the spring 333 oppositely pushes the second stop rim 332 of the slidable sleeve 33, and the slidable sleeve 33 moves to the second end of the body 31, the first stop rim 331 of the slidable sleeve 33 reversely pushes the first face 323 of the retainer 32 so that the locking protrusion 321 of the retainer 32 moves toward the locking position, thus replacing the socket 40 easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A connecting rod device for tools comprising:
a body including a polygonal fitting groove defined on a first end thereof, the body also including a trench formed on an outer wall thereof adjacent to the first end of the body and communicating with the fitting groove;
a retainer partially accommodated in the trench of the body and including a first face and a second face which correspond to the trench, the retainer also including a locking protrusion extending into the fitting groove of the body from a first end of the retainer, and a second end of the retainer extending out of the outer wall of the body;
a slidable sleeve fitted with the outer wall of the body and including a first stop rim arranged on one end thereof so as to push the first face of the retainer, the slidable sleeve also including a pushing element fixed therein so as to push the second face of the retainer, such that the first stop rim and the pushing element of the slidable sleeve push the retainer to move in the trench.

2. The connecting rod device for the tools as claimed in claim 1, wherein trench of the body is in communication with one of corners of the polygonal fitting groove of the body.

3. The connecting rod device for the tools as claimed in claim 1, wherein the body also includes a polygonal fitting column arranged on a second end thereof.

4. The connecting rod device for the tools as claimed in claim 1, wherein the trench of the body has a tilted fence formed on a first side thereof, a straight fence arranged on a second side thereof, and a bottom face defined between the tilted fence and the straight fence.

5. The connecting rod device for the tools as claimed in claim 4, wherein the retainer further includes an extension extending outwardly from two sides of the locking protrusion so as to contact with the bottom face of the trench of the body, and the first face of the retainer corresponds to the tilted fence of the trench, the second face of the retainer corresponds to the straight fence of the trench.

6. The connecting rod device for the tools as claimed in claim 1, wherein the pushing element of the slidable sleeve is a spring, a first end of which pushes the second face of the retainer.

7. The connecting rod device for the tools as claimed in claim 6, wherein the slidable sleeve further includes a second stop rim for pushing a second end of the spring.

8. The connecting rod device for the tools as claimed in claim 7, wherein the second stop rim of the slidable sleeve is a C ring.
